(19) United States
(12) Patent Application Publication
(10) Pub. No.: US 2009/0055651 A1
(43) Pub. Date: Feb. 26, 2009

(54) AUTHENTICATED MEDIA COMMUNICATION SYSTEM AND APPROACH

(76) Inventors: Bernd Girod, Stanford, CA (US); Yao-Chung Lin, Mountain View, CA (US); David P. Varodayan, Stanford, CA (US)

Correspondence Address: CRAWFORD MAUNU PLLC, 1150 NORTHLAND DRIVE, SUITE 100, ST. PAUL, MN, 55120, US

(21) Appl. No.: 12/196,643

(22) Filed: Aug. 22, 2008

Related U.S. Application Data
(60) Provisional application No. 60/957,945, filed on Aug. 24, 2007.

(51) Int. Cl. H04L 9/00

(52) U.S. Cl. 713/176

(57) ABSTRACT

Media authentication is facilitated. In connection with an example embodiment, media is authenticated using an encoded projection of the media that is decoded using the media as an input. A condition of authenticity of the media is determined based upon an indication of distortion of the media characterized by a decoding of the encoded projection.

### RELATED PATENT DOCUMENTS

This patent document claims the benefit, under 35 U.S.C. §119(e), of U.S. Provisional Patent Application Ser. No. 60/957,945, entitled Authenticated Media Communication System and Approach and filed on Aug. 24, 2007; this patent application is fully incorporated herein by reference.

### FIELD OF THE INVENTION

The present invention relates generally to data communications, and more particularly to communications systems and approaches involving use of a projection of the media for authenticating media.

### BACKGROUND

Secure data communication is important in many communication environments, and in particular to network-based communications, to ensure that received data is legitimate. For instance, media authentication is important in many applications of content delivery via untrusted intermediaries, such as peer-to peer (P2P) file sharing or P2P multicast streaming. In these applications, many differently encoded versions of the original media file might exist. Moreover, transcoding and bitstream truncation at intermediate nodes might be required, giving rise to further diversity. On the other hand, intermediaries might tamper with the contents for a variety of reasons, such as interfering with the distribution of a particular file, piggybacking unauthentic content, or generally discrediting a particular distribution system.

Distinguishing the legitimate diversity of encodings from malicious manipulation is a major technical challenge for media authentication systems, and is particularly challenging in environments involving lossy communications. Generally, lossy communication refers to the communication of data in which some data is lost or changed, such as during compression (e.g., JPEG) or manipulation, and lossy channels are those involving data transfer that is characterized by lossy communication. Example channels that employ lossy communications include packet-based channels such as the Internet, mobile device networks and telephone networks. Past approaches to distinguishing legitimate variations from malicious manipulation have included the use of watermarks and media hashes.

A “fragile” watermark can be embedded into the host signal waveform without perceptual distortion. Users can confirm the authenticity by extracting the watermark from the received content. The system design should ensure that the watermark survives lossy compression, but that it “breaks” as a result of a malicious manipulation. Unfortunately, watermarking authentication is not backward compatible with previously encoded contents; unmarked contents cannot be authenticated later. Embedded watermarks might also increase the bit-rate required when compressing a media file.

Media hashing achieves verification of previously encoded media (as well as localization of tampering) by using an authentication server to supply authentication data to the user. Media hashes are inspired by cryptographic digital signatures, but unlike cryptographic hash functions, media hash functions are supposed to offer proof of perceptual integrity. Using a cryptographic hash, a single bit difference leads to an entirely different hash value. If two media signals are perceptually indistinguishable, they should have identical hash values. A common approach of media hashing is extracting features that have perceptual importance and should survive compression. Authentication data is generated by compressing these features or generating their hash values. The user checks the authenticity of the received content by comparing the features or their hash values to the authentication data. However, limitations in this approach relating to compression and otherwise have hindered the successful application of hashing to media authentication.

These and other issues have presented challenges to the communication of data, and particularly to the communication of legitimate media data.

### SUMMARY

The present invention is exemplified in a number of implementations and applications, including embodiments directed to addressing the above-mentioned issues, and some of which are summarized below.

According to an example embodiment of the present invention, media is authenticated using a projection of the media. A distributed encoding of the projection is provided and algorithmically decoded using the media and an editing characteristic for the media, to provide a decoded projection. A condition of authenticity of the media is determined based on the projection of the media and the decoded projection. In some embodiments, the projection has a size that is a function of an editing characteristic of the media, such as that relating to compression or other editing.

According to another example embodiment of the present invention, media is authenticated as follows. A projection of media is generated and processed through a cryptographic hash function to generate a media digest. The media digest is sent to a media recipient together with a distributed encoding of the projection. At the recipient, the encoded projection is decoded using the media as side data together with an editing characteristic of the media to provide a decoded projection therefrom. This decoded projection has characteristics relative to a degree of editing or distortion of the media (side data). The decoded projection is processed through a cryptographic hash function to generate a media digest of the decoded projection, which is compared with the media digest of the projection of the media. A condition of authenticity of the media is determined in response to this comparison.

The above summary is not intended to describe each illustrated embodiment or every implementation of the present invention. The figures, detailed description and claims that follow more particularly exemplify these embodiments.

### BRIEF DESCRIPTION OF THE DRAWINGS

The invention may be more completely understood in consideration of the detailed description of various embodiments of the invention that follows in connection with the accompanying drawings, in which:

FIG. 1 shows a system for media communication and authentication, according to an example embodiment of the present invention;

FIG. 2 shows a system for media communication and authentication, according to an example embodiment of the present invention;

FIG. 3 shows a system for media communication and authentication, according to another example embodiment of the present invention;

FIG. 4A and FIG. 4B respectively show plots of the distribution of output data for legitimate and illegitimate image data, according to another example embodiment of the present invention; and

FIG. 5 shows a factor graph for tampering localization, in accordance with another example embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The present invention is believed to be useful for a variety of authentication and coding applications, and the invention has been found to be particularly suited for use with media authentication approaches and systems. While the present invention is not necessarily limited to such applications, various aspects of the invention may be appreciated through a discussion of various examples using this context.

According to an example embodiment of the present invention, communicated media is authenticated using a projection of the media, an encoding of the projection, and the media-to-be-authenticated. The encoding is decoded using the media-to-be-authenticated as side information, together with information characterizing editing characteristics of the media-to-be-authenticated. A degree of variation or distortion of the decoding, relative to the projection, is used to determine the legitimacy of the media-to-be-authenticated.

In a more particular embodiment, an extension of hashing for media authentication is based upon distributed source coding. An authentication server provides a user with a Slepian-Wolf encoded media waveform projection (bitstream), and the user attempts to decode this bitstream using media-to-be-authenticated as side information. The Slepian-Wolf result indicates that the lower the distortion between the side information and the original (from which the media-to-be-authenticated is originated), the fewer authentication bits are required for correct decoding. By correctly choosing the size of the authentication data, legitimate encoding variations of the media (e.g., due to compression and reconstruction) are distinguished from illegitimate modifications. That is, accurate projection decoding using media-to-be-authenticated that is highly-correlated to the original source requires a low rate of authentication data. However, if the media-to-be-authenticated is poorly-correlated due to illegitimate editing, the same low rate will be insufficient for use as side data and for corresponding authentication.

These approaches and others described herein are applicable to implementation with previously encoded media, regardless of the transmission or storage format. In addition, these approaches are applicable to the authentication of various types of media content such as images, audio, voice, video and 3D graphics. Such authentication is amenable to use in applications including those relating to creative works, surveillance data, and content distribution, with approaches to the latter involving both user-based verification that content is in fact a sincere version of the original, and content distributor-based assurance that its media is being redistributed without dramatic modifications such as unauthorized advertisements.

In connection with various example embodiments, the term projection or projection of media is used to characterize a portion of media, such as an image, audio or video. In this regard, a portion (projection) of media data is used to facilitate the detection or determination of a condition of authenticity of the media from which the projection was taken or derived. Such a condition of authenticity may involve, for example, detecting variation in the media due to unauthorized tampering, or variation in the media due to expected editing characteristics as described herein.

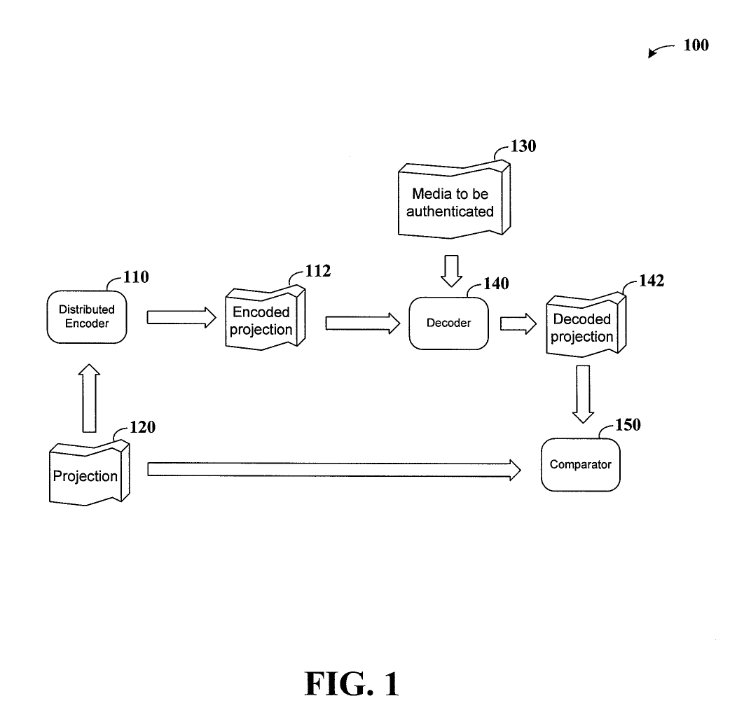

Turning now to the figures, FIG. 1 shows a system 100 for media communication and authentication, according to an example embodiment of the present invention. The system includes a distributed encoder 110 that generates an encoded projection 112 from a projection 120 of media-to-be-authenticated 130. The encoded projection 112 is sent to a decoder arrangement 140, which decodes the encoded projection, using the media-to-be-authenticated 130 and an editing characterization of the media-to-be-authenticated as inputs, to provide a decoded projection 142. The editing characterization may, for example, characterize an expected edit to the media-to-be-authenticated such as those relating to encoding variation, filtering and geometric transformation.

A comparator 150 determines a condition of authenticity of the media-to-be-authenticated based upon the projection 120 and the decoded projection 142. For instance, where the decoded projection 142 corresponds to the projection 120 with expected editing characteristics, the comparator 150 determines that the media-to-be-authenticated is legitimate. However, where the decoded projection corresponds to the projection 120 with expected editing characteristics as well as other characteristics relating to an illegitimate modification of the media-to-be-authenticated, the comparator 150 determines that the media-to-be authenticated is illegitimate.

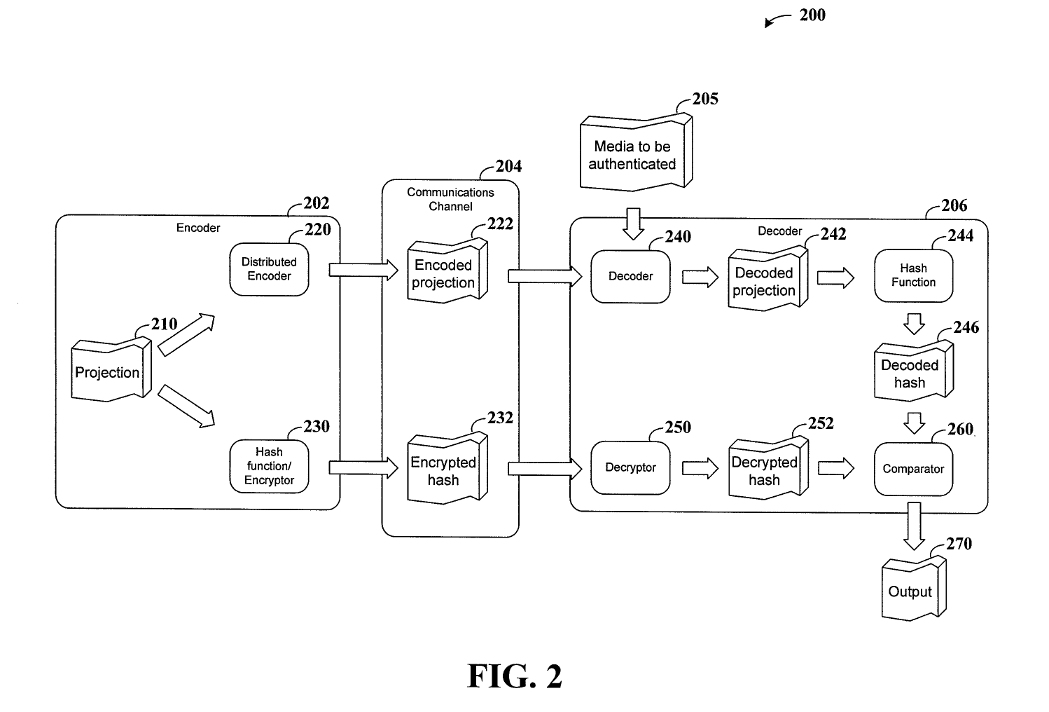

FIG. 2 shows a system 200 for media communication and authentication, according to an example embodiment of the present invention. The system includes an encoder arrangement 202 that generates authentication data and sends the authentication data over a communications channel 204 to a recipient having a decoder arrangement 206 for use in determining a condition of authenticity of media to be authenticated 205. In these contexts, the media to be authenticated 205 may also be communicated over the communications channel 204.

The encoder arrangement 202 uses a projection 210 of the media to be authenticated 205 to generate authentication data. Specifically, a distributed encoder 220 encodes the projection 210 and sends an encoded projection 222 over the communications channel 204 to a recipient employing the decoder arrangement 206. A hash function/encryptor 230 generates a cryptographic hash of the projection 210, encrypts the hash and sends the encrypted hash 232 over the communications channel 204 to a recipient employing the decoder arrangement 206.

A decoder function 240 at the decoder arrangement 206 uses media to be authenticated 205 as side information to decode the projection 222 and generate a decoded projection 242 that is sent to a hash function 244. In some applications, the decoder arrangement 206 uses an editing characteristic of the media to be authenticated 205, such as that relating to compression or filtering, in generating the decoded projection 242. The hash function 244 generates a decoded hash 246 and sends the decoded hash to a binary comparator 260. A decryptor 250 at the decoder arrangement 206 decrypts the encrypted hash 232 to generate decrypted hash 252, and sends the decrypted hash to the binary comparator 260. The binary comparator 260 compares the decoded hash 246 with the decrypted hash 252 and generates an output 270 that is responsive to a degree of distortion in the media to be authenticated 205, thus providing an indication of the authenticity of the media to be authenticated (and any illegitimate characteristics thereof).

In various applications, the size of the projection 210 is set in accordance with an expected or acceptable degree of distortion in the media to be authenticated 205, and in this context, is selectively generated by the encoder arrangement 202. For example, where a known or estimated amount of distortion is determined for a particular set or type of media, the size of the projection 210 is chosen to facilitate favorable decoding at the decoder 240 when the media to be authenticated 205 exhibits an amount of distortion up to this known or estimated amount. Correspondingly, at or below the known or estimated amount of distortion, the comparator 260 generates an output 270 that is favorable (i.e., indicates that the media to be authenticated is legitimate). In this regard, if illegitimate data is included with the media to be authenticated, such as an advertisement or malicious data, the amount of distortion in the media to be authenticated is beyond the known or estimated amount. This distortion is reflected in the decoded projection 242 and, correspondingly, in the comparator output 270.

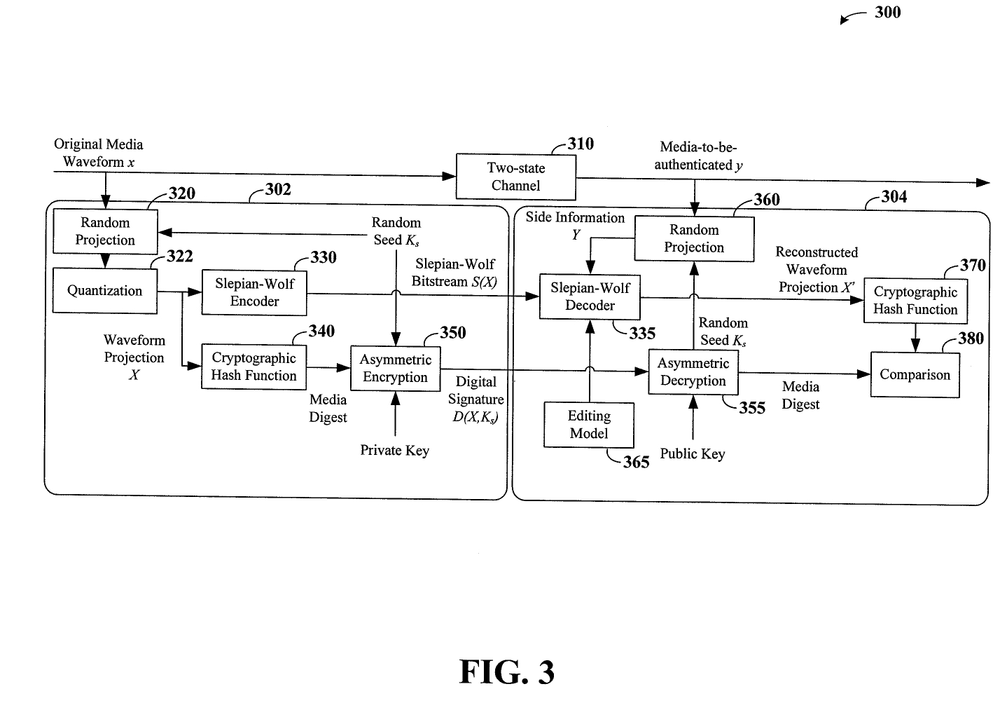

FIG. 3 shows a system 300 for media communication and authentication, according to another example embodiment of the present invention. Source media is denoted as x. A user receives media-to-be-authenticated y (i.e., media x as communicated to the user) as the output of a two-state lossy channel 310 (i.e., a channel over which lossy communications are effected). Generally, the system 300 authenticates media using a projection of the media and an encoding of the projection. The system 300 includes a distributed encoding arrangement 302 (similar to block 202 of FIG. 2), and an arrangement 304 for decoding authenticating media at the output of the channel 310. The distributed encoding arrangement includes a Slepian-Wolf encoder 330 for providing a distributed encoding of the projection in the form of a bitstream. The decoding arrangement includes a Slepian-Wolf decoder 335 for algorithmically decoding the distributed encoding of the projection based on the media and an editing characteristic for the media. The decoder 335 generates a decoded projection at an output for later processing within the arrangement 304. The authentication involves a comparator 380 for determining a condition of authenticity of the media based on the projection of the media and the decoded projection.

More specifically and referring to left-hand side of FIG. 3, the media authentication data source (encoding) arrangement 302 generates authentication data including a Slepian-Wolf encoded lossy version of x using encoder 330 and a digital signature of that version using a hash function 340 and asymmetric encryption 350.

The authentication arrangement 304 (e.g., a recipient/decoder), shown in the right-hand side of FIG. 3, stores statistics of selected worst-permissible legitimate channel conditions (via which the data is delivered) and decodes the authentication data using the media-to-be-authenticated y, received over a channel (310) such as the Internet or a telephone network, as side information for the decoding. Communications on the channel 310 generally involve lossy data compression (e.g., JPEG) or manipulation, and as such the compressed or manipulated lossy data is reconstructed. The authentication data is correctly decoded when the media-to-be-authenticated y is legitimate, and is incorrectly decoded when the media file y is illegitimate. The following description more particularly characterizes example operation of the system 300.

A pseudorandom projection based on a randomly drawn seed Kₛ is applied to the original media x at block 320 and the projection coefficients are quantized at block 322 to yield a projection X. In some implementations, the random projection is blockwise and the block partition is fixed, pseudorandomly assigned or content adaptive. In addition, the quantization intervals at block 322 are fixed or pseudorandomly dithered in different applications.

A Slepian-Wolf encoder 330 derives a Slepian-Wolf bitstream S(X) from X based on rate-adaptive low-density parity-check (LDPC) codes. A cryptographic hash function 340 generates a cryptographic hash value of X (a media digest) and an asymmetric encryptor 350 signs the hash value with a private key to generate a digital signature D(X, Kₛ) that includes the signed hash and a seed Kₛ. For general information regarding distributed source encoding, and for specific information regarding approaches to Slepian-Wolf (distributed source) encoding as may be implemented with these or other embodiments, reference may be made to D. Varodayan, A. Aaron, and B. Girod, “Rate-adaptive codes for distributed source coding,” EURASIP Signal Processing Journal, Special Section on Distributed Source Coding, vol. 86, no. 11, pp. 3123-3130, November 2006, which is fully incorporated herein by reference.

In some applications, authentication data are generated as described above by a server upon request. The server uses a different random seed Ks in responding to each request, and the seed is provided to the authentication arrangement 304 as part of the authentication data to mitigate an attack that confines malicious editing to the nullspace of the projection. For example, where implemented for image media, based on the random seed, for each 16×16 non-overlapping block Bᵢ, a 16×16 pseudorandom matrix Pᵢ is generated by drawing its elements independently from a Gaussian distribution N(1,σ_{z}²) and normalizing so that ∥Pᵢ∥₂=1. The term σ_{z} is chosen at 0.2 empirically. The inner product [symbol] Bᵢ, Pᵢ [symbol] is quantized into an element of X.

The rate of the Slepian-Wolf bitstream S(X) is selected to determine or set a degree of statistical similarity between the media-to-be-authenticated and the original media in order to declare the media-to-be-authenticated as legitimate (i.e., authentic). If the conditional entropy H(X|Y) exceeds the bit-rate R (e.g., in bits per pixels for image media), X can no longer be decoded correctly. Therefore, the rate of S(X) is chosen to distinguish between the different joint statistics induced in the media contents by legitimate and illegitimate channel states. Accordingly, a Slepian-Wolf bit-rate that is just sufficient to authenticate a worst permissible quality is used at the encoder 330, facilitating the detection of illegitimate media data while permitting the acceptance of media that is simply distorted via acceptable communication conditions.

At the authentication arrangement 304, the media-to-be-authenticated y is authenticated using authentication data S(X) and D(X, Kₛ). The media-to-be-authenticated y is projected to Y via random projection 360 in the same way as the projection of media x to X during authentication data generation as described above. A Slepian-Wolf decoder 335 reconstructs X′ from the Slepian-Wolf bitstream S(X) using Y as side information. Decoding is via LDPC belief propagation initialized according to the statistics of the legitimate channel state at the worst permissible quality for the given original media. For general information regarding decoding, and for specific information regarding approaches respectively for using side information in reconstruction and belief propagation approaches that may be implemented in connection with these or other example embodiments, reference may be made to the following: A. Aaron, S. Rane, E. Setton, and B. Girod, “Transform domain Wyner-Ziv codec for video,” in SPIE Visual Communication sand Image Processing Conference, San Jose, Calif., 2004; to A. Wyner, J. Ziv, “The rate-distortion function for source coding with side information at the decoder,” IEEE Transactions on Information Theory, vol. 22, no. 1, pp. 1-10, January 1976; and to A. Liveris, Z. Xiong, and C. Georghiades, “Compression of binary sources with side information at the decoder using LDPC codes,” IEEE Communications Letters, vol. 6, no. 10, pp. 440-442, October 2002, all of which are fully incorporated herein by reference.

The media digest of X′ is computed using cryptographic hash function 370 and compared at 380 to the media digest that is output at 340, decrypted via asymmetric decryption 355 from the digital signature D(X, Kₛ) using a public key. In these contexts, one example approach to generating the media digest involves using a digital signature algorithm that generates a string of bits as a function of the source content (here, the projection) and an encryption key. If the media digests match (e.g., are identical via binary comparison), the media-to-be-authenticated y is determined to be authentic, and if there is no match, the media-to-be-authenticated y is determined to be inauthentic.

In certain embodiments where the media-to-be-authenticated y is determined to be inauthentic, the decoder 335 requests incremental authentication data to infer the location of illegitimate editing by one of several editing models supplied at 365. The editing models are categorized into groups including legitimate editing, and illegitimate editing groups. The legitimate editing may include various compression methods, up/down sampling, geometric transformations and format conversion. The illegitimate editing may include tampering, replacement of content, or one of many other malicious modifications to the media. In some implementations, rate-adaptive distributed source codes are implemented so that more information can be sent to receiver (decoder 335) incrementally to offer additional functions such as tampering localization, some of which are described further below. The location of illegitimate editing is determined and used to facilitate the future communication of authentic media.

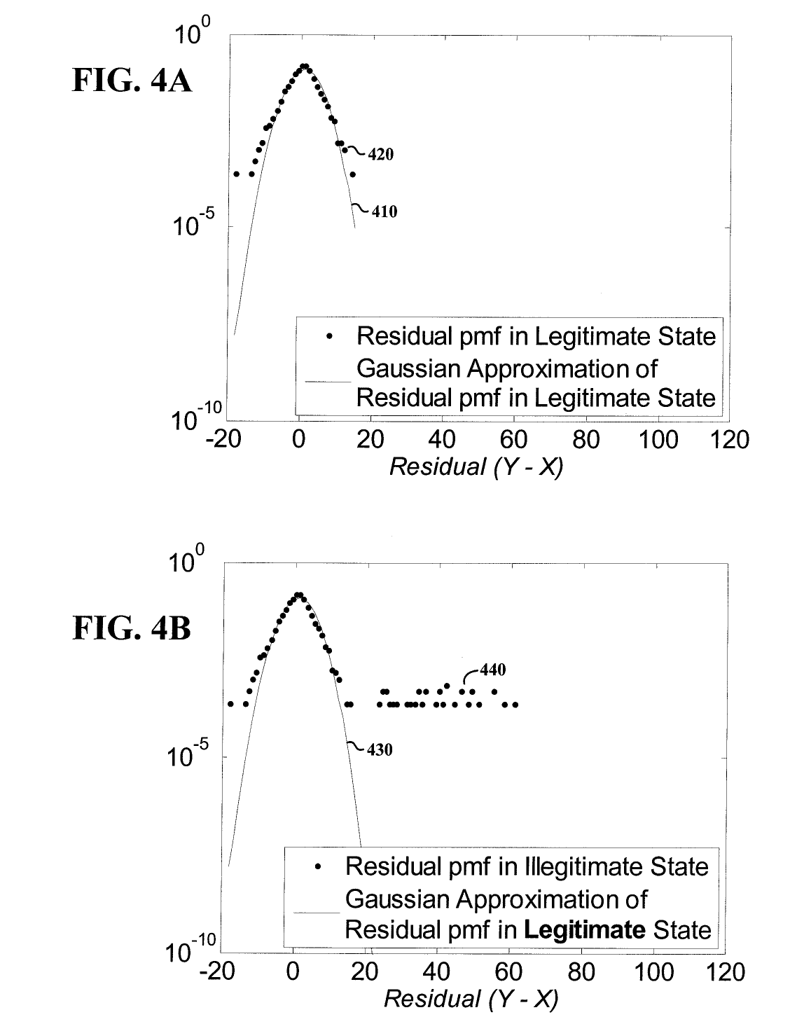

FIG. 4A and FIG. 4B respectively show plots of the distribution of residual data for legitimate and illegitimate image data as communicated in accordance with another example embodiment of the present invention. These plots correspond, for example, to a comparison as described above in connection with FIG. 3. FIG. 4A shows the plotted distribution of residual data 420, and a plotted Gaussian approximation 410 in a legitimate state. In this legitimate case, the actual distribution of residual data 420 largely follows the Gaussian approximation 410.

FIG. 4B also shows the actual distribution of residual data 440 plotted against a similar Gaussian approximation 430, but for an illegitimate state. In this illegitimate case, the actual distribution of residual data 440 reflects a greater residual and, accordingly, does not follow the Gaussian approximation closely.

As shown in the examples of FIG. 4A and FIG. 4B, the joint statistics of an original image x and its corresponding image-to-be-authenticated y vary depending upon the state of the channel via which the image is communicated. This is illustrated by the plotted distribution of a residual D=Y−X, where X and Y are, respectively, image projections of x and y (e.g., as discussed above with FIG. 3). The samples of the projection residual D are weighted sums of quantization errors, and the distribution of D resembles a Gaussian, by the central limit theorem. In the illegitimate channel state in FIG. 4B, the image samples in the tampered region are unrelated to those of the original image, giving the distribution of D non-negligible tails. This modification of the joint statistics of X and Y is exploited for authentication in connection with these embodiments.

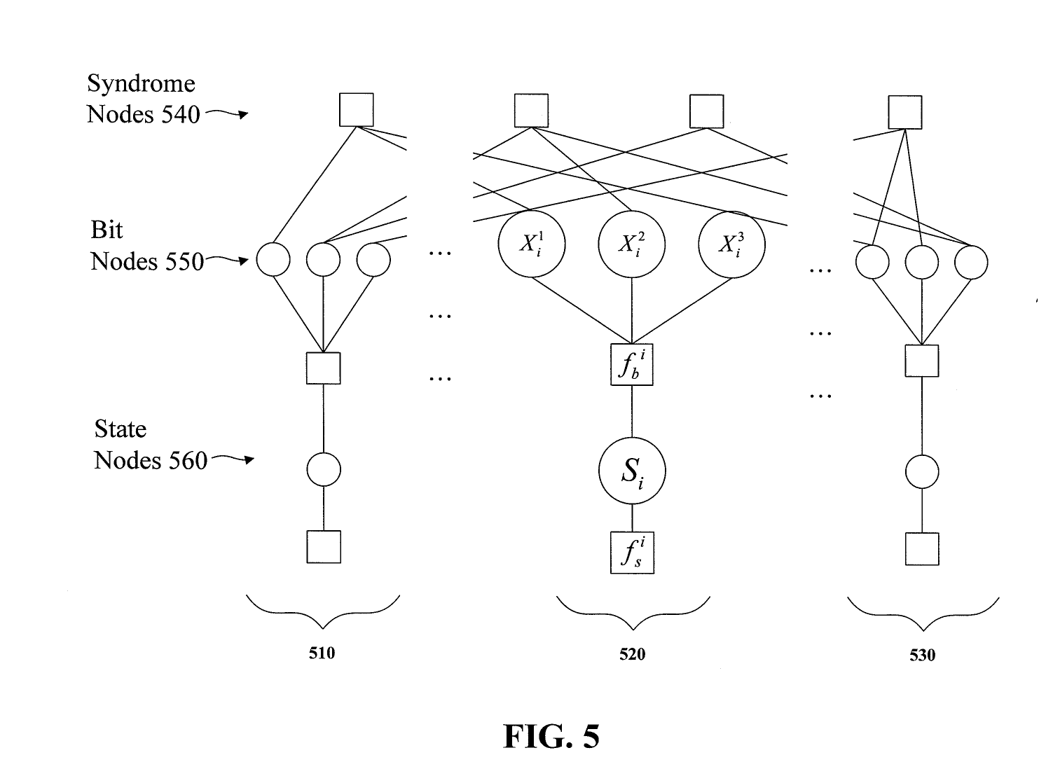

As discussed briefly in connection with different applications above, tampering localization is selectively carried out in connection with various embodiments. With media that is determined to be illegitimate, a portion of encoded data is used to identify tampered pixels with confidence, while correctly classifying untampered blocks. In some applications, a Slepian-Wolf bitstream of less than about 10% of the compressed media size is used for tampering localization, and in other applications, the contiguity of the tampered regions in a decoding model is used to facilitate a low-bitstream size for localization. The following describes more particular approaches to localization with media including image data, using the system 300 in FIG. 3 as an example and with further reference to FIG. 5 in characterizing an example factor graph implemented for the same.

An authentication problem such as that discussed above with FIG. 3 generally involves a decision as to authenticity using the sum of channel states Sᵢ for media (e.g., over all blocks in an image). That is, the authenticity determination hinges upon whether ΣᵢSᵢ=0 or Σ₁Sᵢ>0. In the case that the media is inauthentic (ΣᵢSᵢ>0), the tampering localization problem can be formulated as deciding on Sᵢ for each block, given the Slepian-Wolf bitstream S(X) and the digital signature D(X).

Where rate-adaptive LDPC codes are used for Slepian-Wolf coding as described with FIG. 3, the authentication data is re-used in localization decoding at the decoder 335. Incremental localization data is sent through the Slepian-Wolf bitstream S(X) from the Slepian-Wolf encoder 330. The localization decoding for an image uses bitplanes together to estimate the channel state Sᵢ per block. To facilitate this approach and rate-adaptivity for authentication and localization, joint bitplane coding is implemented using a single Slepian-Wolf bitstream for transmitted bitplanes for encoding as well as for decoding. For general information regarding coding and for specific information regarding joint bitplane coding that may be used in connection with these example embodiments, reference may be made to D. Varodayan, A. Mavlankar, M Flierl, and B. Girod, “Distributed grayscale stereo image coding with unsupervised learning of disparity,” in IEEE Data Compression Conf., Snowbird, Utah, March 2007, which is fully incorporated herein by reference.

The decoder 335 applies a sum-product algorithm using the factor graph in FIG. 5 to estimate each channel state likelihood P(Sᵢ=1). Generally, FIG. 5 shows groups 510, 520 and 530 of syndrome nodes 540, bit nodes 550 and state nodes 560. Decoding is initialized with the syndrome nodes values S(X) and the side information Y (from 360). In terms of the factor graph, the joint probability of the bits of the image projection X and the channel states given the syndrome values and the side information can be factored as follows. The factor at each syndrome node is an indicator function of the satisfaction of that syndrome constraint. The factor connected to each state node fₛⁱ(Sᵢ)=P(Sᵢ). The factor f_{b}ⁱ(Xᵢ, Sᵢ)=P(Xᵢ |Yᵢ, Sᵢ). When Sᵢ=0, the factor f_{b}ⁱ(Xᵢ, 0) is proportional to the integral of a Gaussian distribution with mean Yᵢ and a fixed variance σ² over the quantization interval of Xᵢ. When Sᵢ=1, the factor f_{b}ⁱ(Xᵢ, 1) is uniform. The iterations of belief propagation terminate when the hard decisions on bits of X satisfy the constraint imposed by the syndrome S(X). Each block Bᵢ of y is declared to be tampered if P(Sᵢ=1)>α, a fixed decision threshold. Other thresholds are determined in connection with various embodiments. For general information regarding sum-product algorithms, and for specific information regarding implementations of sum-product algorithms in connection with these example embodiments, reference may be made to F. R. Kschischang, B. J. Frey, and H.-A. Loeliger, “Factor graphs and the sum-product algorithm,” IEEE Trans. Inform. Theory, vol. 47, no. 10, pp. 498-519, 2001, which is fully incorporated herein by reference.

As would be apparent to the skilled artisan, various types of electronic circuits can be used to implement the modules or functional blocks discussed above. Depending on the application and available implementation resources, the blocks discussed above in connection with FIGS. 1, 2 and 3 may be implemented using (semi-)programmable computers, discrete logic including custom data-processing architectures, and programmable logic devices (“PLD”), and any combination thereof.

The references cited in the above-referenced provisional patent application, to which priority is claimed and which is fully incorporated herein by reference, describe various approaches that may be implemented in connection with one or more example embodiments of the present invention, and are also fully incorporated herein by reference.

The various embodiments described above are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. For instance, such changes may include modifying the order and content of the various authentication steps, using different legitimate or illegitimate variations of media-to-be-authenticated in decoding steps, or using different distributed encoding/decoding approaches. Such modifications and changes do not depart from the true spirit and scope of the present invention, which is set forth in the following claims.

What is claimed is:

1. A method for authenticating media using a projection of the media where a distributed encoding of the projection is accessible, the method comprising:
based on the media and an editing characteristic for the media, algorithmically decoding the distributed encoding and providing a decoded projection therefrom; and
determining a condition of authenticity of the media based on the projection of the media and the decoded projection.

2. The method of claim 1, further including providing the projection as a portion of media data at a size that is a function of an editing characteristic of the media.

3. The method of claim 1, wherein algorithmically decoding the distributed encoding includes algorithmically decoding the distributed encoding based upon an illegitimate editing characteristic for the media.

4. The method of claim 1, wherein the media used in algorithmically decoding is received over a lossy channel.

5. The method of claim 1, wherein
the media used in algorithmically decoding is received over a lossy channel, and
the projection has a size that is a function of a characteristic of the media as delivered over the lossy channel.

6. The method of claim 1, wherein determining a condition of authenticity of the media includes
generating a media digest using the projection,
generating a media digest using the decoded projection, and
determining the condition of authenticity based on an indication of similarity between the media digests.

7. The method of claim 1, further including identifying a portion of the media that is inauthentic by
estimating a channel state likelihood for each of a plurality of data blocks of the media, and
identifying a portion of the media as inauthentic in response to the estimated channel state likelihood for a data block in the portion of the media exceeding a predetermined threshold value.

8. The method of claim 1, further including identifying a portion of the media that is inauthentic by
encoding and sending incremental localization data from the media,
using the incremental localization data, applying a sum-product algorithm to estimate each channel state likelihood for data blocks of the media, and
identifying data blocks in the media as inauthentic in response to the estimated channel state likelihood for data blocks of the media exceeding a threshold likelihood corresponding to inauthentic media.

9. A method for authenticating media, the method comprising:
generating a media digest for a projection of the media using a cryptographic hash function;
generated a distributed encoding of the projection;
communicating the media, the media digest and the encoded projection to a recipient; and
at the recipient,
decoding the encoded projection using the media as side data input and providing a decoded projection therefrom,
generating a media digest for the decoded projection using a cryptographic hash function,
comparing the media digest for the decoded projection with the media digest for the projection of the media, and
determining a condition of authenticity of the media in response to the comparison.

10. The method of claim 9, further including selecting a projection size for media data as a function of a communication distortion characteristic of the media and forming the projection of the media as a portion of the media data at the selected projection size.

11. The method of claim 9, further including
determining legitimate encoding variations of the media,
determining a distortion characteristic using the legitimate encoding variations, and
forming a projection of the media as a function of the distortion characteristic.

12. The method of claim 9, wherein decoding the encoded projection includes using an editing model for the projection.

13. The method of claim 9, wherein
generating a media digest includes generating a digital signature from which a media digest can be generated via decryption,
communicating the media digest includes communicating the digital signature, and
the step of comparing includes decrypting the digital signature to provide the media digest.

14. The method of claim 9, wherein, for each set of media to be authenticated,
a media digest is generated using a different random seed,
the random seed is communicated to the recipient, and
decoding the encoded projection includes generating the side data with a projection of the media using the random seed.

15. The method of claim 9, wherein decoding the encoded projection using the media as side data input and providing a decoded projection therefrom includes providing a decoded projection having a degree of statistical similarity to the projection of the media that corresponds to a distortion characteristic of the media.

16. The method of claim 9,
further including generating the projection at a size that is a function of a communication distortion threshold of the media, the threshold corresponding to an expected level of distortion present in the communicated media,
wherein generating a media digest for the decoded projection includes generating a media digest that matches the media digest for the projection of the media in response to the distortion level of the media being less than the threshold, whereby the step of determining includes determining that the media is authentic in response to the media digests matching as indicated via the step of comparing.

17. A method for communicating and authenticating image data, the method comprising:
determining a level of distortion of the image data in response to predefined image encoding approaches to be used in communicating the image data;
for a projection of the image, determining a number of authentication bits needed to correctly decode the projection as a function of the determined level of distortion;
generating a projection of the image having a size corresponding to the determined number of authentication bits;
generating an image digest of the projection using a cryptographic hash function;
generating an encoded version of the projection;
communicating the image, the image digest and the encoded projection to a recipient; and
at the recipient,
decoding the encoded projection using the image as an input to form a decoded projection,
generating an image digest of the decoded projection, and
determining that the image is authentic in response to the image digests matching each other.

18. The method of claim 17, further including forming the projection using a portion of the image data.

19. A system for authenticating media using a projection of the media and an encoding of the projection where a distributed encoding of the projection is accessible, the system comprising:
a decoding arrangement to algorithmically decode the distributed encoding of the projection based on the media and an editing characteristic for the media, and to provide a decoded projection therefrom; and
an authenticating arrangement to determine a condition of authenticity of the media based on the projection of the media and the decoded projection.

20. The system of claim 19, further including a distributed encoding arrangement to provide a distributed encoding of the projection, wherein the distributed encoding arrangement forms the projection of the media by forming media data from a portion of the media at a size that is a function of an editing characteristic of the media.

21. The system of claim 19, further including a tampering localization arrangement to
estimate the channel state likelihood for each of a plurality of data blocks of the media, and
identify a portion of the media as inauthentic in response to the estimated channel state likelihood for a data block in the portion of the media exceeding a predetermined threshold value.
